(19) United States
(12) Patent Application Publication
(10) Pub. No.: US 2006/0218392 A1
(43) Pub. Date: Sep. 28, 2006

(54) Spectrum use authorization method, system and apparatus

(76) Inventor: David Johnston, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/089,997

(22) Filed: Mar. 25, 2005

(51) Int. Cl. H04L 9/00

(52) U.S. Cl. 713/156

(57) ABSTRACT

An embodiment of the present invention provides a method of spectrum use authorization, comprising using a certificated declaration of spectrum licensed by licensed users of said spectrum to authenticate said users. The certificated declaration may provide information on transmitter location, channels occupied and an interference footprint or profile and allow a recipient of such information to determine that an occupied channel is genuinely occupied by a licensed user. The certificated declaration also may allow an unlicensed device to build and maintain a list of incumbent users and allows an unlicensed device to compare location and interference contour data against its own location and transmitter power to determine if it will interfere. Further, it may allow a license holder to distribute information about its presence out of band of the signal to be protected and a license holder to distribute information about its presence over a predetermined geographic area. The certificate may be a standard X.509 certificate with additional fields. An embodiment of the present invention further may comprise transmitting the certificated declaration in band with a licensee's transmissions and may aggregating said certificated declarations by equipment manufacturers and placing them in equipment to be used in said spectrum or making said certificated declarations available over the internet enabling unlicensed equipment to access licensee information from sources other than the licensed transmitter. An embodiment of the present invention also provides an apparatus, comprising a transceiver capable of using a certificated declaration of spectrum licensed to authenticate users of said spectrum.

### BACKGROUND

Wireless networks and wireless communication have become prevalent throughout society creating the need for increased capacity and faster and more reliable wireless communication techniques. Incumbent user detection and protection is a topic of growing interest in wireless communication. Recent proposals for operating in the broadcast TV bands in the US (it is understood that the present invention is not limited to broadcast TV bands) suggests a system that may detect licensed users of spectrum and so avoid causing them interference, while being able to use spectrum in an unlicensed manner when it does not find a licensed user is present.

However, the mechanisms for incumbent user detection currently proposed are deficient in that they lack the ability to detect a signature and therefore there is no sure guarantee that there is no licensed user present. Further, any detection based on transmission format is going to be tied to a specific technology and so not useable in multiple bands or geographies. Also, there may be a hidden node problem which may afflict incumbent user detection systems and such mechanisms may be open to abuse by unlicensed users masquerading as license users in order to gain unequal access to the spectrum.

Thus, a strong need exists for an improved spectrum use authorization method, system and apparatus.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the interaction of licensed and unlicensed users of a licensed spectrum without certificated declarations of spectrum licensed; and

FIG. 2 illustrates the interaction of licensed and unlicensed users of a licensed spectrum using certificated declarations of spectrum licensed.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

An embodiment of the present invention provides a certificated declaration of spectrum licensed, along with information on transmitter location, channels occupied and an interference footprint or profile—although it is understood that this information is for illustrative purposes only and any other information may be provided as well. When represented in a computer readable form, this may allow the recipient of such information to determine that an occupied channel is genuinely occupied by a licensed user and enable an unlicensed device to compile and maintain a list of incumbent users. Further, it may allow an unlicensed device to compare location and interference contour data against its own location (E.G. GPS) and transmitter characteristics to determine if it will interfere and allow the license holder to distribute information about its presence out of band of the signal to be protected. Also, it may allow the license holder to distribute information about its presence over a wider geographic area. Although not limited in this respect, a standard X.509 certificate with additional fields would be a suitable format.

License holders generally are licensed by a single body (E.G. the FCC in the US). Therefore, it is possible for a certificate to be signed by a Certificate Authority (CA) run by the licensing body. Alternatively, a traditional CA (such as Verisign®) could issue signed certificates to license holders, based on evidence that the licensee holds the license.

The License may be transmitted in band with the licensee's transmissions; however, it may also be sent on other channels. Further, licenses could be aggregated and placed in equipment or could be made available over the Internet so that unlicensed equipment may access their licensee information from sources other than the licensed transmitter.

Although not limited to this enumeration, by using a signed certificate, the unlicensed user may:
Securely distinguish between real licensees and imposters;
Determine more detailed information about the licensee's transmissions;
Transmitter location;
Transmitter power, channel, bandwidth;
Transmission format;
The tolerable interference contour of the signal; and
Avoid the hidden node problem.

Again, although not limited to this list, by using a signed certificate, the licensed user may:
Expect less unwanted interference from unlicensed users; and
Protect its spectrum from unlicensed imposters masquerading as the license holder, using the spectrum.

By using signed certificates to determine licensed use of spectrum, the unlicensed user may at least be able to securely distinguish between real licensees and imposters and determine more detailed information about the licensee's transmissions, transmitter location, transmitter power, channel, bandwidth, transmission format, the tolerable interference contour of the signal. Further, the signed certificates may enable the avoidance of the hidden node problem.

Also, by using signed certificates to declare licensed use of spectrum, the license holder may expect less unwanted interference from unlicensed users, protect its spectrum from unlicensed imposters masquerading as the license holder, using the spectrum, and use out of band communications to communicate its license certificates to unlicensed equipment.

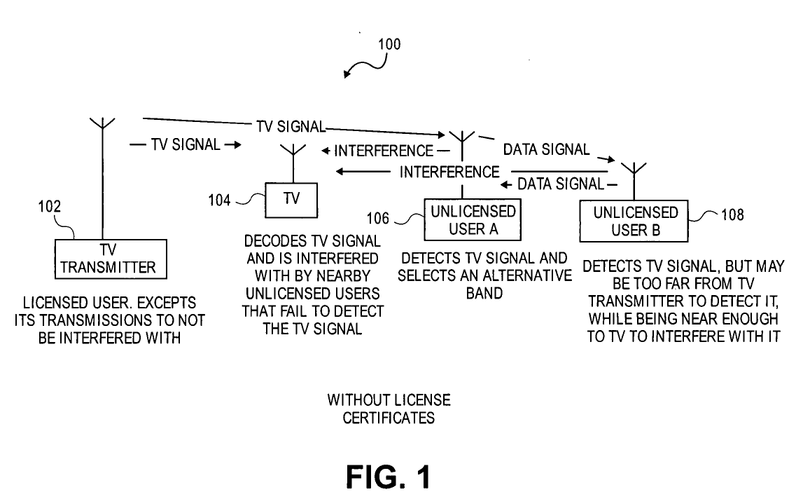

Turning now to FIG. 1, shown generally at 100, is an illustration of an embodiment of the present invention without licensed certificates. Herein, a licensed user, such as, but not limited to, TV transmitter 102 expects it transmissions not to be interfered with. The transmissions from the TV transmitter 102 are received at TV receiver 104. In this embodiment unlicensed user A 106 may be wirelessly communicating data to unlicensed user B 106. Because this transmission may be in the same channel as TV transmitter 102 and TV receiver 104, either or both unlicensed users 106 and 108 may a cause interference with the TV transmitter 102 and TV receiver 104. Even if unlicensed user A detects the signal from TV transmitter 102 and then selects an alternative band, unlicensed user B may be too far from TV transmitter 102 to detect the TV transmitter 102 transmissions, but close enough to TV receiver 104 to interfere with it. This may be referred to as the hidden node problem.

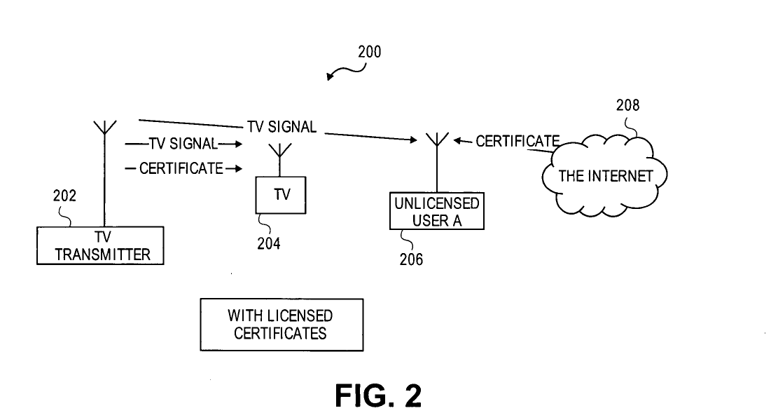

Referring now to FIG. 2 is an embodiment of the present invention which utilizes licensed certificates. In this embodiment, TV transmitter 202 (a licensed user) expects interference free transmissions and may include with its transmissions a licensed certificate. TV receiver 204 receives transmissions from TV transmitter 202. Unlicensed user A 206 may receive the licensed certificates from the TV transmissions or from another source, such as the Internet or a neighboring device 208—this would eliminate the hidden node problem. The certificate information may, in addition to alerting unlicensed user A 206 of the presence of the TV transmissions and of interference potential, provide the location of the TV transmitter 202, the channel it is transmitting on and a likelihood of interference. By using the licensed certificates of the present invention, a much higher likelihood of spectrum sharing without interference to licensed users from unlicensed users is anticipated.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method of spectrum use authorization, comprising:
using a certificated declaration of spectrum licensed by licensed users of said spectrum to authenticate said users.

2. The method of claim 1, further comprising including in said certificates information on transmitter location, channels occupied and an interference footprint or profile.

3. The method of claim 2, wherein said certificate allows a recipient of such information to determine that an occupied channel is genuinely occupied by a licensed user.

4. The method of claim 2, wherein said certificate allows an unlicensed device to build and maintain a list of incumbent users.

5. The method of claim 2, wherein said certificate allows an unlicensed device to compare location and interference contour data against its own location and transmitter power to determine if it will interfere.

6. The method of claim 2, wherein said certificate allows a license holder to distribute information about its presence out of band of the signal to be protected and a license holder to distribute information about its presence over a predetermined geographic area.

7. The method of claim 1, wherein said certificate is a standard X.509 certificate with additional fields.

8. The method of claim 1, further comprising transmitting said certificated declaration in band with a licensee's transmissions.

9. The method of claim 1, further comprising aggregating said certificated declarations and placing them in equipment to be used in said spectrum.

10. The method of claim 1, further comprising making said certificated declarations available over the internet or other data networks enabling unlicensed equipment to access licensee information from sources other than the licensed transmitter.

11. An apparatus, comprising:
a transceiver capable of using a certificated declaration of spectrum licensed to authenticate users of said spectrum.

12. The apparatus of claim 11, wherein said certificates contain information on transmitter location, channels occupied and an interference footprint or profile.

13. The apparatus of claim 12, wherein said certificate allows a recipient of such information to determine that an occupied channel is genuinely occupied by a licensed user.

14. The apparatus of claim 12, wherein said certificate allows an unlicensed device to build and maintain a list of licensed incumbent users of spectrum.

15. The apparatus of claim 12, wherein said certificate allows an unlicensed device to compare location and interference contour data against its own location and transmitter power to determine if it will interfere.

16. The apparatus of claim 2, wherein said certificate allows a license holder to distribute information about its presence out of band of the signal to be protected and a license holder to distribute information about its presence over a predetermined geographic area.

17. The apparatus of claim 1, wherein said certificate is a standard X.509 certificate with additional fields.

18. The apparatus of claim 11, wherein said transceiver is capable of transmitting said certificated declaration in band with a licensee's transmissions.

19. The apparatus of claim 11, wherein said certificated declarations are aggregated and placed in equipment to be used in said spectrum.

20. The apparatus of claim 11, wherein said certificated declarations available over the internet enabling unlicensed equipment to access licensee information from sources other than the licensed transmitter.

21. An article, comprising:
a storage medium having stored thereon instructions, that, when executed by a computing platform results in:
using a certificated declaration of spectrum licensed by licensed users of said spectrum to authenticate said users.

22. The article of claim 21, further comprising including in said certificates information on transmitter location, channels occupied and an interference footprint or profile.

23. The article of claim 22, wherein said certificate allows a recipient of such information to determine that an occupied channel is genuinely occupied by a licensed user.

24. The article of claim 22, wherein said certificate allows an unlicensed device to build and maintain a list of incumbent users.

25. The article of claim 22, wherein said certificate allows an unlicensed device to compare location and interference contour data against its own location and transmitter power to determine if it will interfere.

26. The article of claim 22, wherein said certificate allows a license holder to distribute information about its presence out of band of the signal to be protected and a license holder to distribute information about its presence over a predetermined geographic area.

27. A wireless communication system, comprising:
a predetermined wireless spectrum capable of being utilized for wireless communication between a plurality of wireless devices; and
a certificated declaration capable of being used by users of said wireless spectrum to determine which users are licensed to use said wireless spectrum.

28. The system of claim 28, wherein said certificated declaration contains information on transmitter location, channels occupied and an interference footprint or profile.

29. The system of claim 28, wherein said certificated declaration allows an unlicensed device to build and maintain a list of incumbent users.

30. The system of claim 28, wherein said certificated declarations are aggregated by equipment manufacturers and placed in equipment to be used in said spectrum.
